(19) United States
(12) Patent Application Publication
(10) Pub. No.: US 2016/0283547 A1
(43) Pub. Date: Sep. 29, 2016

(54) SYSTEM AND METHOD FOR IMPLEMENTING MULTI-FACETED SEARCH QUERIES

(71) Applicant: CARSALES.COM LTD, Richmond, Victoria (AU)

(72) Inventors: Michael RIDGWAY, Blackburn (AU); Aaron HEMAT-SIRAKY, Yarraville (AU); Khan THOMPSON, Frankston (AU)

(73) Assignee: CARSALES.COM LTD, Richmond, Victoria (AU)

(21) Appl. No.: 15/031,463

(22) PCT Filed: Mar. 12, 2014
(86) PCT No.: PCT/AU2014/000243

§ 371 Date: Apr. 22, 2016

(30) Foreign Application Priority Data
Oct. 24, 2013 (AU) 2013904109

(51) Int. Cl. G06F 17/30

(52) U.S. Cl. CPC G06F 17/30398; G06F 17/30477; G06F 17/3056; G06F 17/30973

(57) ABSTRACT

A computer-implemented method of guiding a user during the construction of a search query to locate an item of interest in a database, wherein a search index of the database is a hierarchical data structure that includes at least one aspect of items with the aspect having facets. The method includes receiving a search query from a user, building a search expression data structure according to the search query, expanding the search expression data structure to determine the results for at least one facet available to refine the user's search query and presenting a representation of the results of the user's search query along with the result for the at least one facet to the user, thus providing guidance to the user for development of the search query regarding the existence of valid results. The method is useful to avoid incorrect or NULL results.

### FIELD OF THE INVENTION

The invention relates to a system, method and computer software instruction code to guide users during the construction of a search query when attempting to locate item(s) of interest in a database of items. The system, method and computer software instruction code of the present invention is particularly useful for relatively large databases that store a substantial amount of information relating to items that may be of interest to a user.

### BACKGROUND OF THE INVENTION

Computer databases have become ubiquitous and are generally used on a daily basis by a large proportion of the population either in their personal lives or in commerce. Increasingly, databases are storing larger amounts of data and the increased deployment and use of databases continues as the population across the world relies upon computer communications networks to locate and identify relevant data. As a result, the number of searches of databases in order to locate data necessary to fulfill personal needs or achieve a commercial outcome is increasing substantially.

As computer databases store increasingly large amounts of data, the process of conducting a search of a database becomes increasingly longer. Although the increase in search time is not a linear relationship with the size of the database, the search time does increase with an increased amount of data in the database. Database programmers are mindful of the increasing delays associated with conducting searches of databases.

The increasing delay is a particular problem in instances where a database is provided to prospective consumers for the purpose of searching for an item of interest. Organisations that operate databases to allow prospective consumers to conduct searches are fully aware that prospective consumers have a relatively low frustration threshold and in the event that a search is considered to be taking too long, the prospective consumer will generally abandon their search rather than waiting, and will conduct an alternative search. A particular problem associated with a user search experience, is the fact that a user is generally not aware of the data in the database pertaining to items of interest. Accordingly, users sometimes submit a search query for which a “NULL” result is returned. Of course, a NULL result to a user's search query is a waste of time and upon receiving a NULL result a user generally becomes frustrated. Accordingly, users are effectively required to gradually locate item(s) of interest by a process of elimination.

Irrespective of the reason, anything that delays locating an item of interest will cause user frustration.

In the particular instance of a database that stores items for sale, the contents of the database is dynamic and uncertain at any point in time due to the listing and de-listing of items as they are offered for sale and either withdrawn from sale or sold. As a result, it is not possible for users to know in advance when conducting a search whether there will be any results of interest. Whilst requiring users to refine their searches by a process of elimination causes delay and frustration, conversely, a system and method that foreshadows a successful search toward tangible results would avoid presenting the user with annoying NULL search results.

Of greatest concern is the possibility that a consumer that becomes frustrated during a search may redirect their search to an alternative database provided by a competitor organization thus resulting in lost revenue to the search service provider.

For the above reasons, it is very important to ensure that the search experience avoids frustrating the user and in particular, it is important to reduce the amount of time for a prospective consumer to conduct a search and locate item(s) of interest as quickly as possible.

The problem associated with a frustrating search experience is exacerbated when allowing users to conduct a multi-faceted search query. Increasingly, users are demanding the flexibility to conduct searches that combine a number of facets in their search query in order to specifically detail the item (or group of items) that they are seeking. The problem is further compounded when attempting to provide users with the ability to refine their searches where the user may combine multiple facets of an item with logical OR operations.

Accordingly, there is a need for an improved system, method and computer instruction code for conducting searches of databases that provides users with greater searching flexibility such that they can refine their search query whilst also avoiding the frustration presently experienced by users when conducting a search.

The reference to any prior art in the specification is not, and should not be taken as, an acknowledgement or any suggestion that the prior art forms part of the common general knowledge in Australia.

### SUMMARY OF THE INVENTION

In the present invention, the problem of providing users with increased searching flexibility whilst at the same time avoiding lengthy delays and a frustrating search experience is addressed by providing a user with the ability to “look ahead” whilst constructing their search query so that they are aware of the existence of valid results according to refinements that they could apply to their search.

In this regard, it will be appreciated by skilled readers that the term “refinement” means an improvement to the search. Whether a search is improved or not is determined by the user. In some instances, a refinement may mean a reduction to the number of search results whereas in other instances, a refinement may mean an increase in the number of search results as a result of including additional facets of items in which the user is interested. Similarly, references to “items” with respect to a database of items will be understood by skilled readers to include tangible objects such as new or second hand goods and also, intangible items such as services or employment positions.

In one aspect, the present invention provides a computer-implemented method of guiding a user during the construction of a search query in an attempt to locate an item of interest in a database of items, wherein the search index of the database is a hierarchical data structure that includes at least one aspect of the items in the database with the aspect having facets where the facets enumerate possible values of the aspect, the method including receiving a search query from a user, building a search expression data structure according to the search query, expanding the search expression data structure to determine the results for at least one facet available to refine the user's search query and presenting a representation of the results of the user's search query along with the result for the at least one facet to the user, thus providing guidance to the user for development of the search query regarding the existence of valid results for the at least one facet, wherein, the search expression data structure includes logical OR operations and expanding the search expression data structure to determine the existence of valid results for the at least one facet includes removing components in the expression tree of the search query including facets that relate to the at least one facet in order to avoid generating incorrect results.

In an embodiment, components in the expression tree of the search query that are removed are those components that include facets for which the facet under consideration is a sibling within the family of facets that enumerate an aspect.

In an embodiment, the data structure representing the set of possible values of a facet is a tree structure with each non-leaf node representing an aspect of an item and leaf nodes representing facets of items.

In another embodiment, the search expression tree is operable to include any combination of logical AND, logical OR and/or logical NOT operations. In yet another embodiment, the search expression tree is operable to also include any additional combination of logical EXCLUSIVE OR operations.

In one embodiment, when expanding the search expression tree to determine the existence or otherwise of valid search results for a facet that could be selected as a refinement, the components of the expression tree for which results are already known are used in the determination of search results for the refinement facet rather than re-executing searches relating to those components of the search expression tree.

In another embodiment, the user is provided with the facility to remove previously entered refinements from the search query which effectively accommodates a “change of mind” as the user is developing their search query.

In another embodiment, in addition to determining the presence or otherwise of valid facet refinements and presenting those to the user as guidance whilst developing their search query, the count value obtained for the valid refinements are also presented to the user. In this embodiment, the ability of the user to “look ahead” with respect to their search query allows them to avoid annoying NULL search results and also to consider the available quantity of refinements for each facet as they develop their search.

In another aspect, the present Invention provides a computer-implemented system to guide a user during the construction of a search query in an attempt to locate an item of interest in a database of items, wherein the search index of the database is a hierarchical data structure that includes at least one aspect of the items in the database with the aspect having facets where the facets enumerate possible values of the aspect, the system including at least one processor executing computer instruction code to receive a search query from a user, at least one processor executing computer instruction code to build a search expression data structure according to the search query, at least one processor executing computer instruction code to expand the search expression data structure to determine the results for at least one facet available to refine the user's search query, wherein the search expression data structure includes logical OR operations and expanding the search expression data structure to determine the existence of valid results for the at least one facet includes removing components in the expression tree of the search query including facets that relate to the at least one facet in order to avoid generating incorrect results, and at least one processor executing computer instruction code to present a representation of the results of the user's search query along with the result for the at least one facet to the user, thus providing guidance to the user for development of the search query regarding the existence of valid results for the at least one facet.

In another aspect, the present invention provides computer instruction code which, when executed by one or more processors effects the steps of the method detailed above.

### BRIEF DESCRIPTION OF THE DRAWINGS

In order that the present invention may be readily understood and put into practical effect, reference will now be made to the accompanying figures and following description that provides details of one or more embodiments of the invention. Throughout the figures, reference numerals that are repeated throughout the figures are used to refer to the same element in each respective Figure. With reference to the accompanying Figures:

FIG. 1 is a diagrammatic representation of a user interface that enables a user to enter terms of a search query;

FIG. 1a is a diagrammatic representation of an expression tree constructed to determine the results of a search query entered into the user interface of FIG. 1 to search for Blue Sedans manufactured by General Motors Holden;

FIG. 1b is a diagrammatic representation of a user interface that presents to the user with a range of additional options to expand the initial search query and the user expands the search query of FIG. 1a to also include Blue Sedans manufactured by the Ford Motor Corporation;

FIG. 1c is a diagrammatic representation of an expression tree that is constructed as a result of a user's initial search query entered in the user interface of FIG. 1 and expanded as a result of the additional options selected by the user in FIG. 1b;

FIG. 2 is a diagrammatic representation of a user interface identifying the number of valid results for various facets (in this instance location) that may be used to refine the user's search query;

FIGS. 2a and FIG. 3 are diagrammatic representations of amended expression trees based upon the expression tree constructed in FIG. 1c with the additional refinement based upon location of vehicles in respect of the states of Victoria and New South Wales respectively;

FIG. 4 is a diagrammatic representation of a user interface identifying the existence of valid results for facets that may be used to refine the results of the user's search query, in this instance, the facet being the “make” of vehicles;

FIG. 4a is a diagrammatic representation of an expression tree constructed in respect of the user query (FIG. 1c) with appropriate amendment of the expression tree to remove components of the expression that would otherwise cause incorrect results for the refinement under consideration;

FIG. 4b is a diagrammatic representation of the incorporation of a refinement in a user's search query;

FIG. 5 is a diagrammatic representation of a user interface detailing further facets that may be used to refine the user's search query of FIG. 1c where the facet detailed in FIG. 5 is the model of the vehicle;

FIGS. 5a and 5b are diagrammatic representations of an expression tree based upon the expression tree in FIG. 1c with amendments to determine valid results for further facets that may be used to refine the results of the user's search query;

FIG. 6 is a diagrammatic representation of an expression tree constructed as a result of a user entering search terms for a Blue Sedan that is either a Holden Astra OR a Ford Falcon; and

FIG. 7 is a diagrammatic representation of an expression tree as a result of a user entering search terms for a Blue sedan that is either a Holden Astra where the Astra has a CD Badge OR a Ford Falcon.

### DETAILED DESCRIPTION OF EMBODIMENT(S) OF THE INVENTION

The following detailed description of embodiment(s) of the invention refers to the accompanying figures. Although the description includes exemplary embodiments, other embodiments are possible and changes may be made to the embodiments described without departing from the spirit and scope of the invention.

In the present specification, an embodiment of the invention will be described which relates to the provision of search services in respect of new or second hand vehicles that are available to members of the public for purchase. Whilst the embodiment(s) below are described in terms of new or used vehicles, the invention is not restricted to such items and it will be recognized by skilled persons that the invention is equally relevant, and applicable to, databases in which range of alternative items of interest are stored and from which users seek to locate items of interest to themselves.

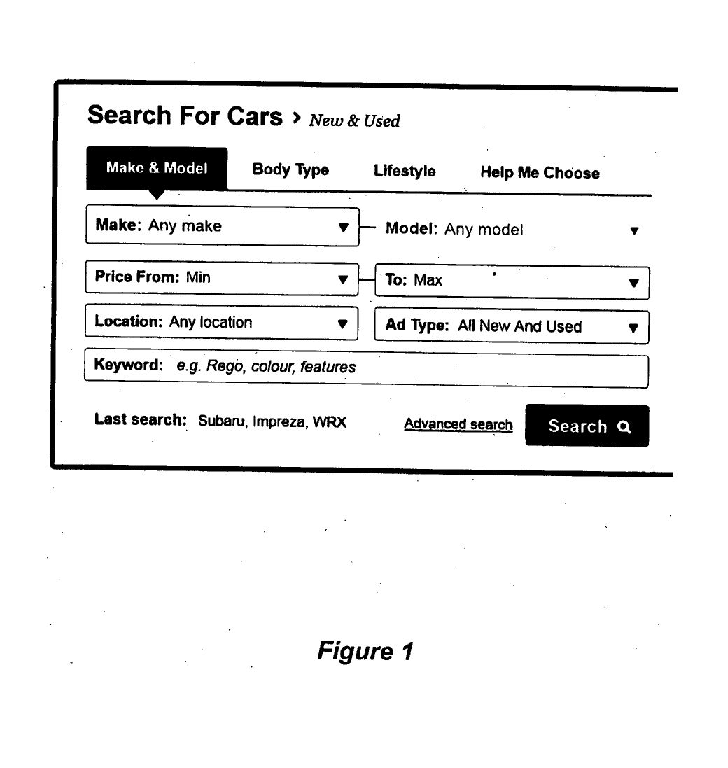

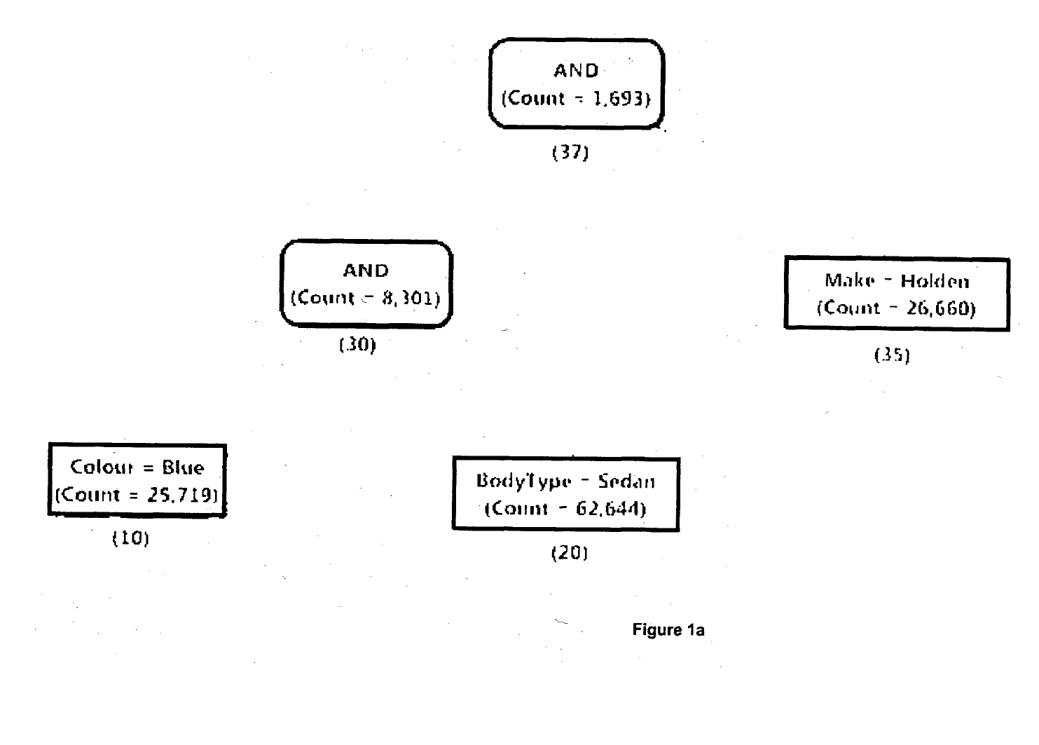

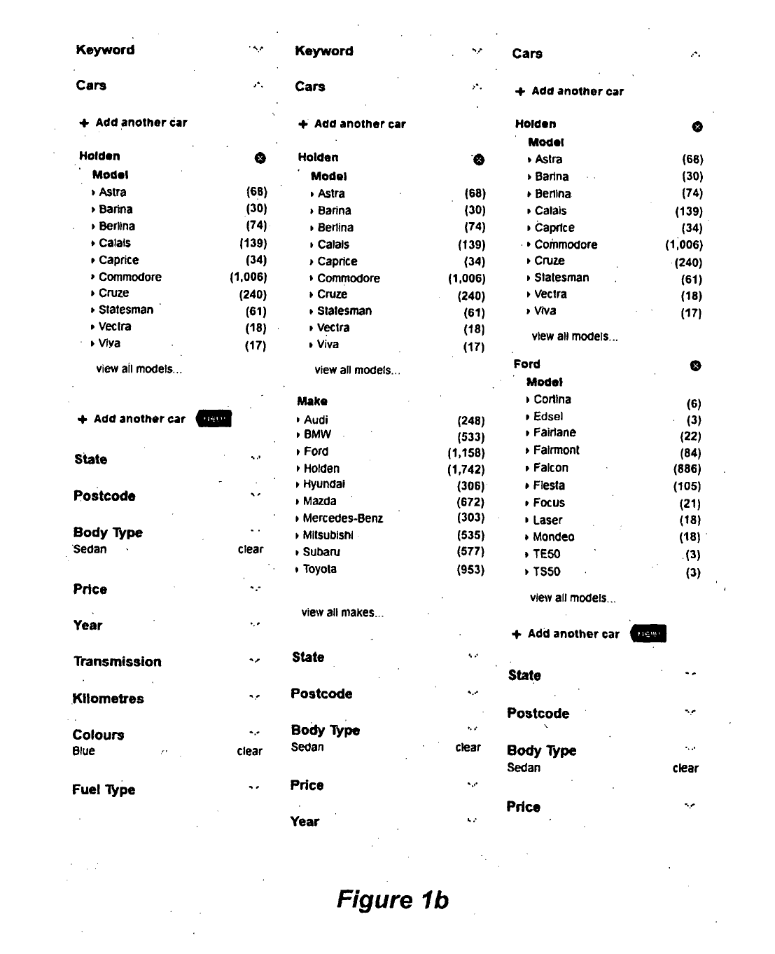

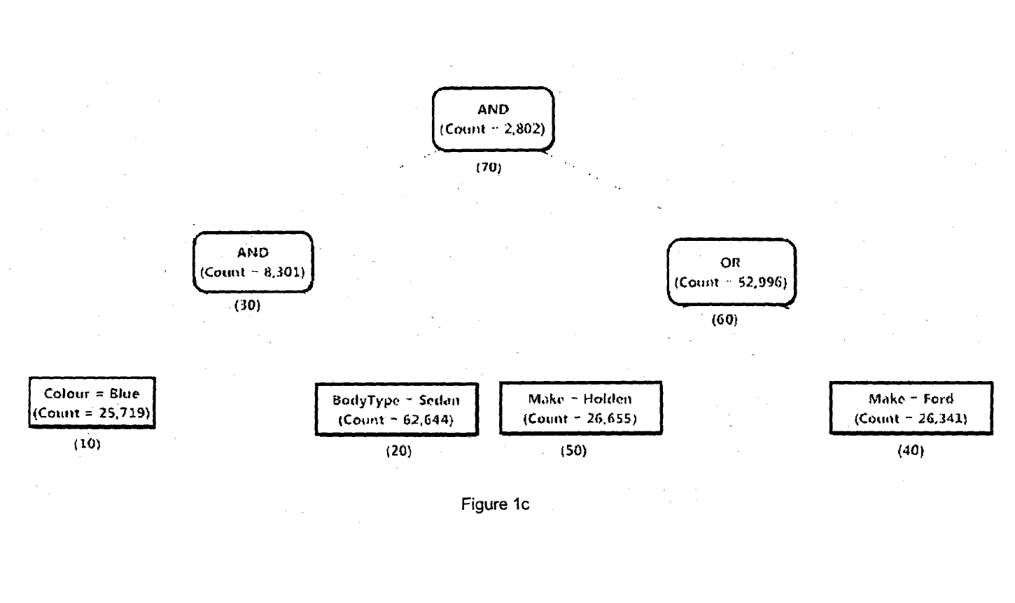

With reference to FIG. 1, a diagrammatic representation of a user interface presented to a user is provided in which the user has a range of search options relating to vehicles that are stored in a database. The user is presented with a range of aspects from which the user may construct a search query and in the instance of FIG. 1, the user may select a Make and Model of a vehicle or a body Type. As a result of a search query entered by the user for a vehicle manufactured by General Motors Holden that has a Sedan body type and is coloured Blue, the expression tree constructed to determine the results of the user's search query is depicted in FIG. 1a.

As will be noted in FIG. 1a, the expression tree includes a search for all vehicles that are coloured Blue (represented by node 10) and the results of this sub-search are combined according to a logical AND operation with a sub-search of all vehicles that have a Sedan body style (represented by node 20).

The results of the logical AND are represented by the expression tree node 30.

Similarly, a sub-search of all vehicles made by General Motors Holden is conducted and the results are represented by node 35. Since the user is interested in Blue Sedans that are manufactured by General Motors Holden, the results of the sub-searches (nodes 30 and 35) are subject to a logical AND operation performed upon the search results represented by nodes 30 and 35 to produce the final result for the user's query which is represented by the root of the expression tree, namely node 37.

FIG. 1b is a diagrammatic representation of a user interface that is presented to the user to allow them to expand the initial search query to include another Make or Model or another Body Type. As a result of selecting another Make of vehicle, namely Ford, the user query is now directed to a Blue Sedan manufactured by either the Ford Motor Corporation or General Motors Holden.

With reference to FIG. 1c, a diagrammatic representation of the expression tree is illustrated which has been constructed as a result of the user's search query for a vehicle that is coloured Blue, has a Sedan Body style and is either made by the Ford Motor Corporation (node 40) or General Motors Holden (node 50). The results of these two searches are combined by a logical OR operation and the result is represented by node 60. Of course, to determine the number of Blue Sedans that are manufactured by either the Ford Motor Corporation or General Motors Holden, the search results of node 30 and node 60 are combined by a logical AND operation and the results of the search are represented by the root node 70.

Whilst the embodiment depicted in FIGS. 1a, 1b and 1c includes a two-step process wherein the user initially enters search terms in respect of a Blue Sedan that is manufactured by General Motors Holden, and subsequently expands the search to also include Blue Sedans manufactured by the Ford Motor Corporation, it will be recognized by skilled readers that a user interface may be presented to a user allowing them to enter all of these search terms in the one interface in a single step process rather than the two step process depicted.

Further refinements and the steps to determine the availability of valid results for each refinement are described below.

At this stage, whilst the system may present the user with search result that provides an indication of the total number of vehicles that are stored in the database that satisfy the search criteria of a Blue Sedan that is either manufactured by the Ford Motor Corporation or General Motors Holden, the system and the user at this stage are unaware of any refinements to the search that will render valid results. In order to guide the user in relation to valid refinements (i.e. refinements that will not generate a NULL result), further searches are conducted in respect of the available refinerfients and presented to the user.

In an embodiment, facets enumerate all possible values of their respective aspect and refinements according to all possible facets are searched and presented to the user. In the instance of the present embodiment, valid search results for facets including the “location” of the vehicle, the “make” of the vehicle or the “model” of the vehicle are determined and presented to the user. This additional information provides the user with the ability to “look ahead” with respect to their search query and they are effectively guided to avoid NULL results as they enter further search terms.

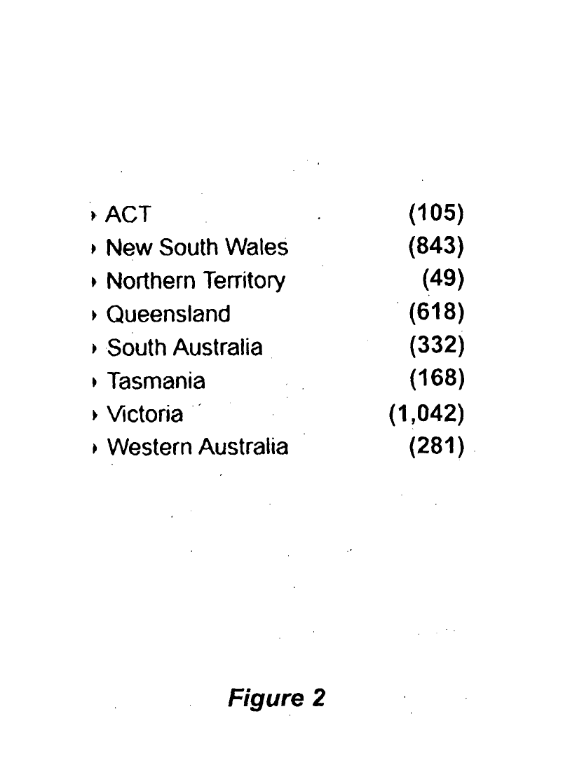

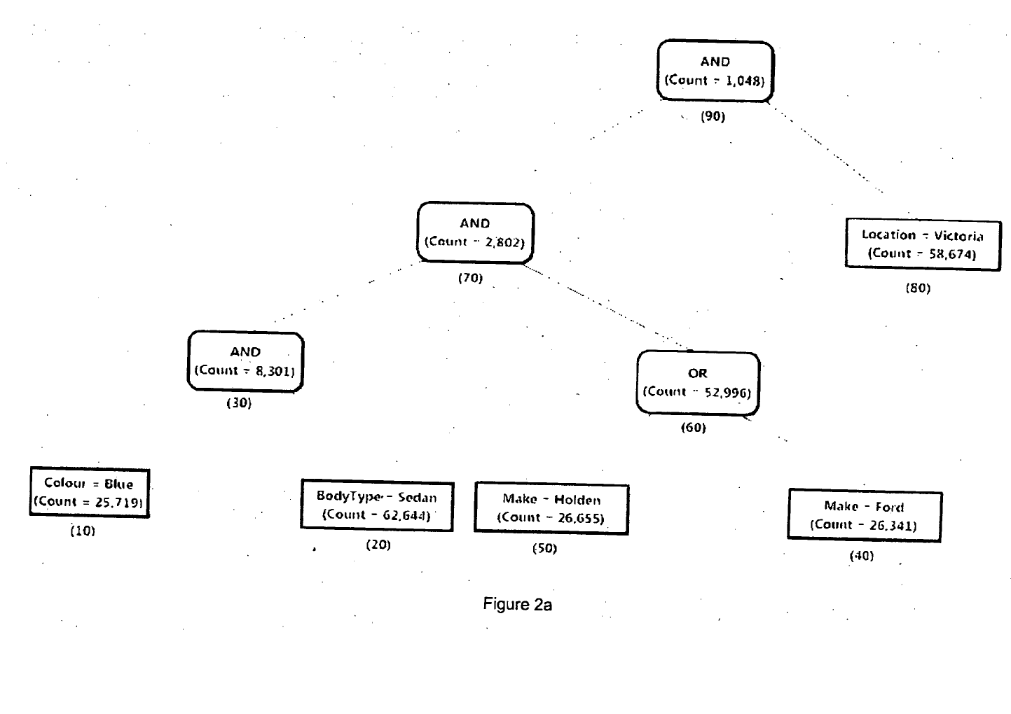

With reference to FIG. 2, the user is presented with the results of the facet of “location” with respect to their search query. In this regard, in the event that the user were to elect to refine their search query to restrict the results to only those vehicles available in Victoria, they can see from the user interface depicted in FIG. 2 that 1,048 vehicles according to their search query reside in the state of Victoria. Similarly, in the same user interface depicted in FIG. 2, the user can see that 843 vehicles reside in the state of New South Wales according to the parameters of their search query.

With reference to FIG. 2a, a diagrammatic representation of the amendments made to the expression tree of FIG. 1a is provided with the addition of a refinement based upon the location of the vehicles that are identified in the user's search query detailed in FIG. 1a.

In FIG. 2a, the particular refinement being determined is how many Blue Coloured Sedans made by either the Ford Motor Corporation or General Motors Holden are located in the state of Victoria. When incorporating this refinement in the search query, the search query is first analysed to determine whether the aspect of “location” already exists as a parameter in the query. In the event that “location” is not already present in the user's search query, the entire result of the search query (exemplified in FIG. 1a) is subject to a logical AND operation with the sub-query in respect of all vehicles located in the state of Victoria. In this regard, the sub-search of all vehicles located in Victoria is represented at node 80 which is subject to a logical AND operation with the search results of the user's query (node 70). The result of the logical AND operation is represented by root node 90 of the new expression tree that incorporates the refinement in respect of vehicles of interest located in the state of Victoria.

In one embodiment, incorporation of the “location” refinement in the user's search query is implemented without requiring the re-execution of the entire expression tree but rather, combines the already known result of the search query of FIG. 1a with the results of a sub-search of all vehicles located in the state of Victoria with a logical AND operation.

Similarly, to incorporate other “location” refinements in respect of the user's search query,' the results of the search query are subjected to a logical AND operation in respect of search results according to different locations such as the state of New South Wales, South Australia, Western Australia, etc. Whilst it is possible to re-execute the user's search query to “update” the results, in order to minimize delay, it is possible to rely upon the already known results of the user's search and only execute a sub-search in respect of the particular “location” and logically AND the results with the results of the user's search query.

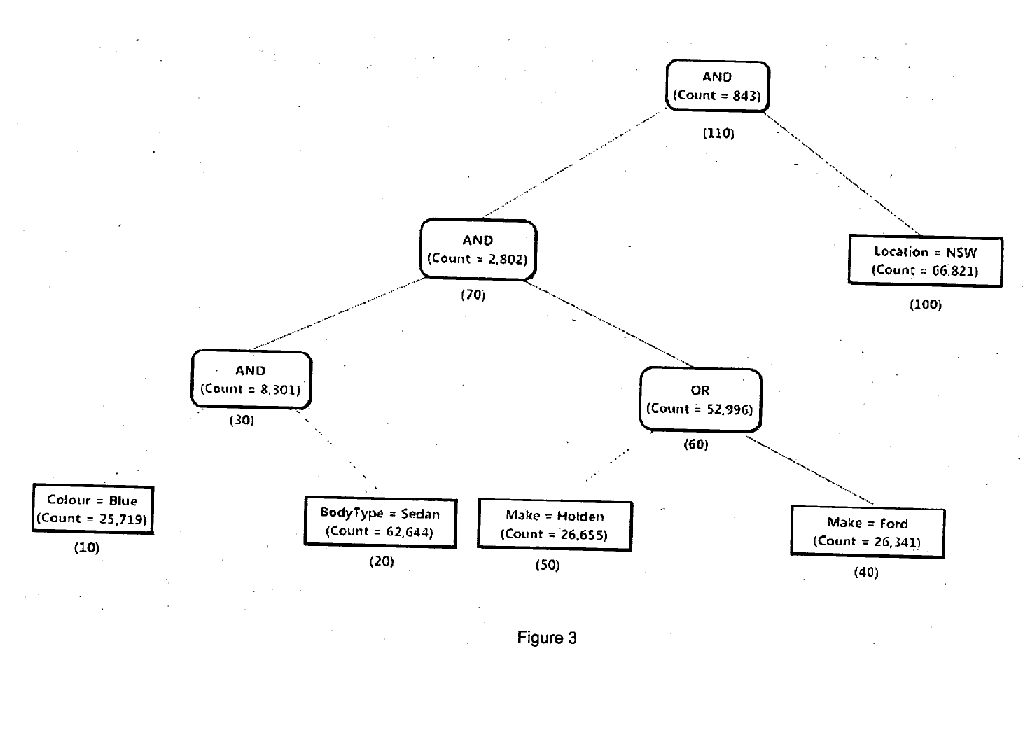

In the instance of FIG. 3, a further example of a “location” refinement is provided wherein the user's search query of FIG. 1a is refined to determine whether any Blue coloured Sedans made by either the Ford Motor Corporation or General Motors Holden are located in the state of New South Wales (represented by node 100). In this regard, the search results of the user's query (represented by 70) are subjected to a logical AND operation with the results of a sub-search of all vehicles located in the state of New South Wales (node 100) and the result of the logical AND operation is represented by the root of the new expression tree (node 110).

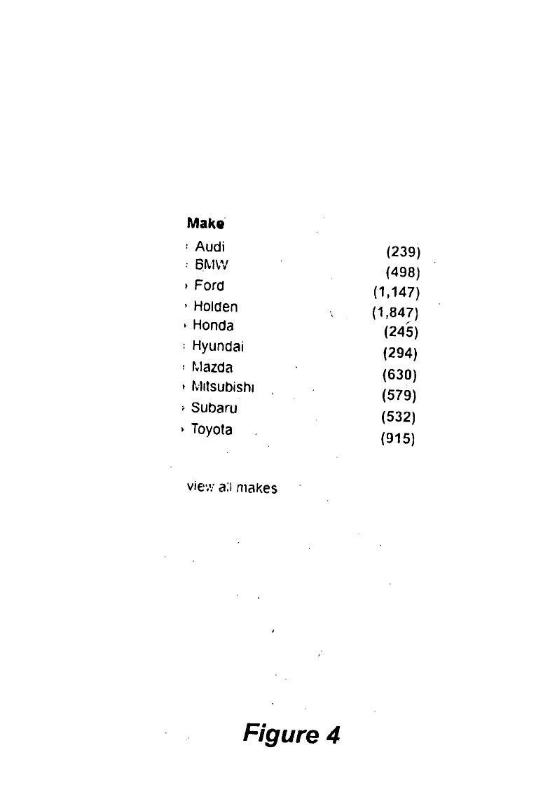

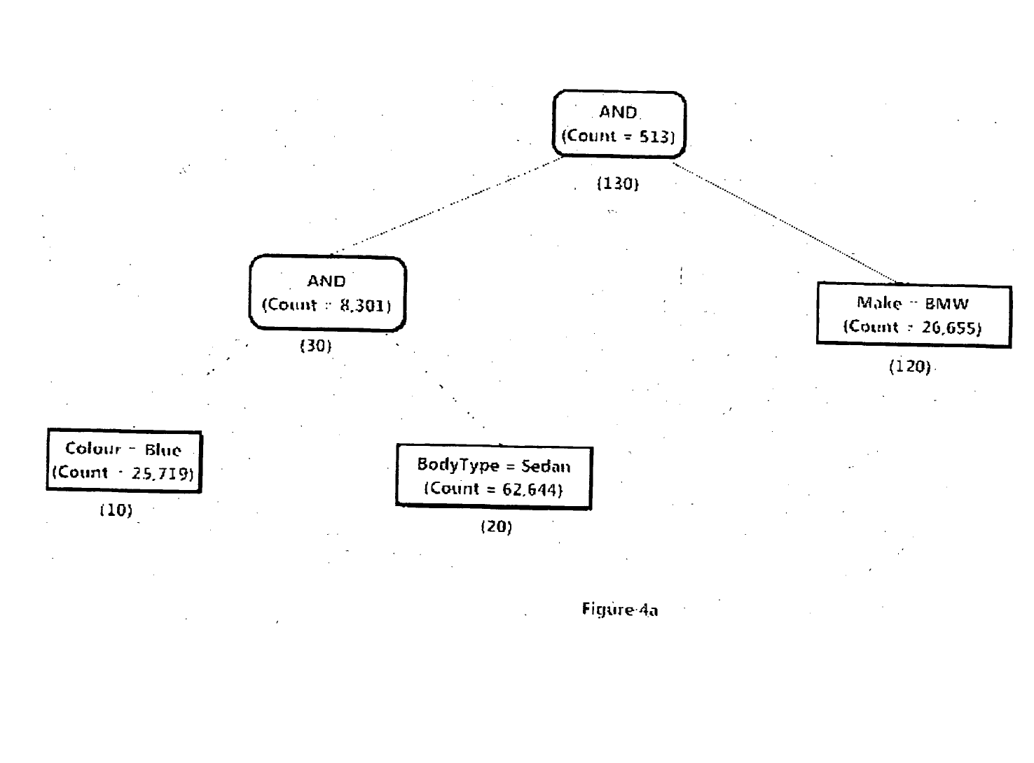

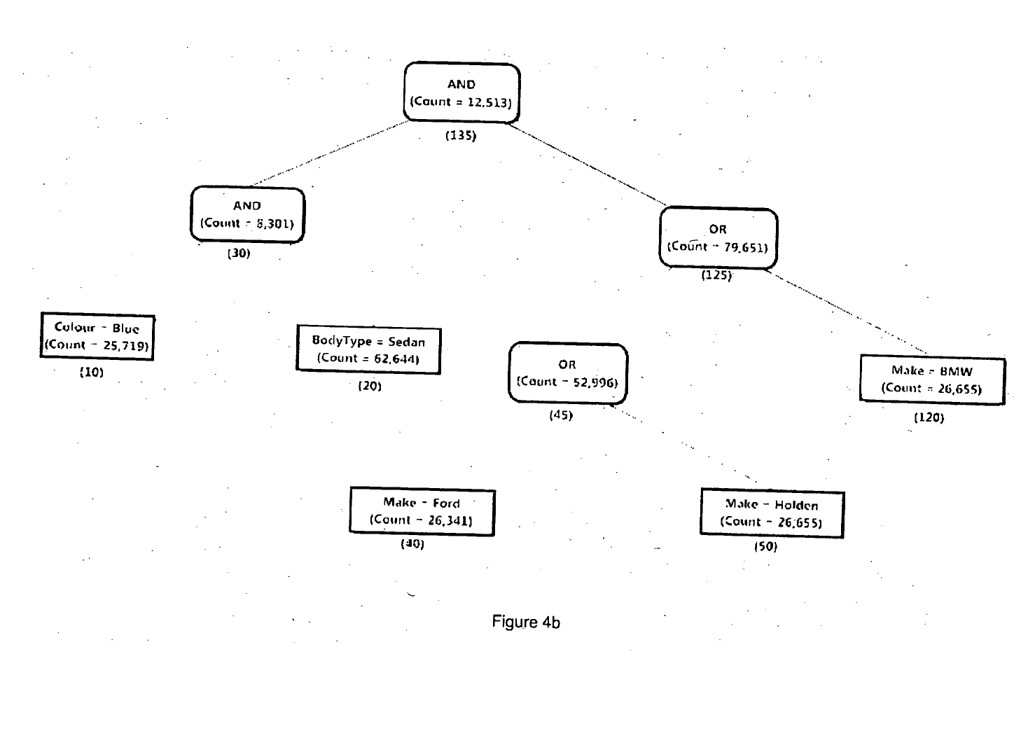

Similar to the determination of valid refinements according to the facet “location”, FIG. 4 is a diagrammatic representation of valid refinements presented to the user according to the facet “make” as applied to the search query. In the instance of FIG. 4, the user can see that if they were to refine their search query by “make” thus replacing the previous selection of “Ford OR Holden” with “Ford OR Holden OR BMW”, then 498 valid search results exist for a vehicle manufactured by either of the three manufacturers that has a “Sedan” body style that is coloured “Blue”.

With reference to FIG. 4a, a refinement according to the aspect “make” is effected with respect to the user's search query and in this instance, the incorporation of this refinement includes the initial step of removing those aspects of the expression tree in which the “make” facet already exists. Hence, in the present example of FIG. 4a, the search results in respect of the query for all vehicles made by either the Ford Motor Corporation OR General Motors Holden is removed (i.e. nodes 40, 50 and 60). Further, the results of a sub-query for all makes according to “BMW” is implemented and the results of this search query are represented by node 120. Conducting a logical AND operation between the search results represented by node 30 (all vehicles coloured Blue and with a Sedan body style) with the search results of all vehicles that have a make of BMW is conducted and the results represented by node 130. As a result, the search results at node 130 represent the result of all vehicles that satisfy the search criteria of a Blue Sedan made by BMW.

When considering a sub-search to determine valid results for a facet refinement, it is important to analyse the expression tree to determine the existence of parameters in the expression tree aspect for facets to which the facet under consideration as a refinement is a sibling. In particular, in the event that an expression tree already includes a facet that is a sibling, of the facet being considered as a refinement, it is important to remove the component of the expression tree relating to the existing facet, otherwise, incorrect results for the refinement may be generated.

In the event that the user were to include the refinement of the additional “make” of BMW as a refinement to the search query, the resulting expression tree representing the inclusion of this refinement is detailed in FIG. 4b. In this instance, the component of the expression tree that initially included the “Ford OR Holden” sub-search component is replaced with a sub-search for “Ford OR Holden” combined with a logical OR operation with the results of a sub-search for make=BMW . Further, the search components are re-executed and all remaining available refinements are determined (as occurs subsequent to each search query execution) and the results of the search query according to the expression tree along with results for all available refinements are presented to the user.

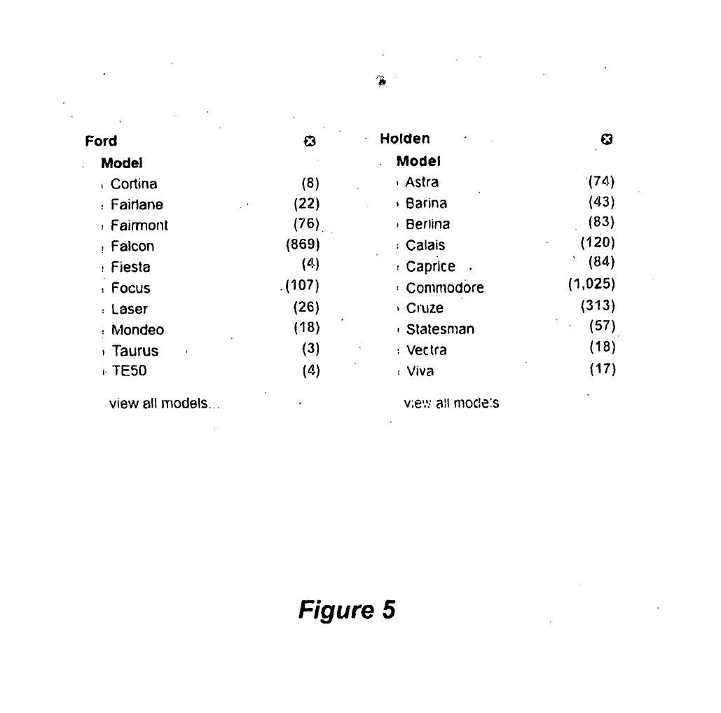

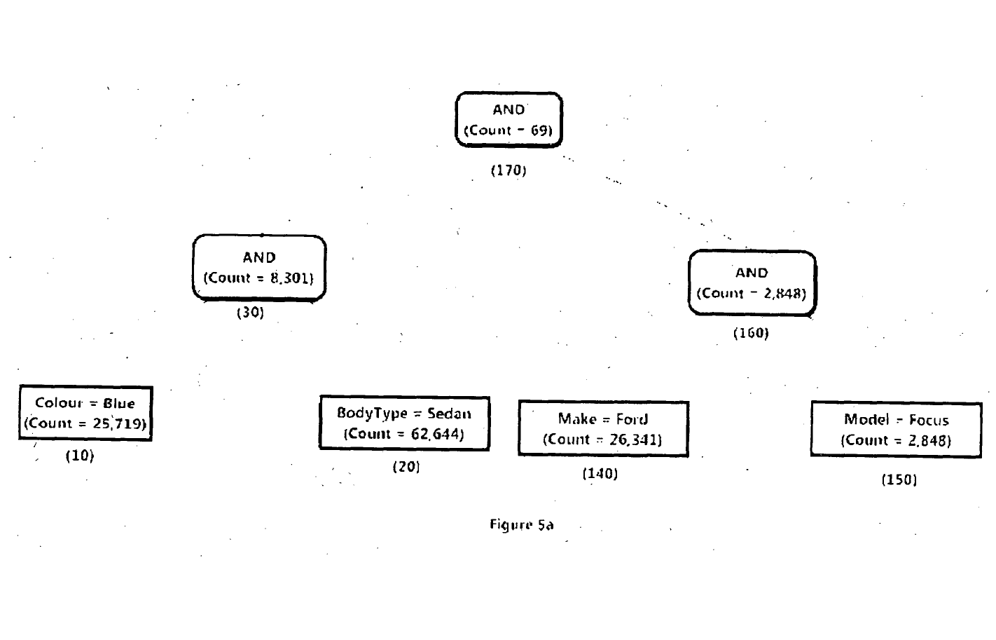

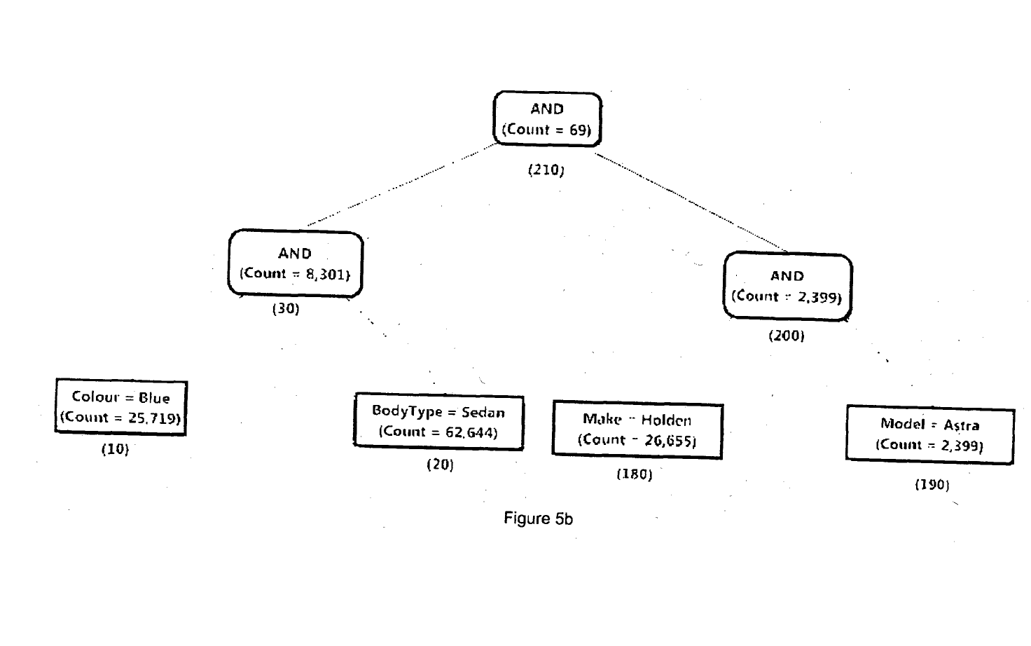

With respect to FIG. 5, a diagrammatic representation of the user interface is depicted in which the user is presented with the refinement results for a refinement to their search query based upon various “models” of vehicles manufactured by The Ford Motor Corporation and General Motors Holden. In the example, the user is presented with information indicating that a refinement to their search query to locate vehicles manufactured by The Ford Motor Corporation of the model type “Focus” is valid with 107 results and refining their search query to vehicles manufactured by General Motors Holden with the model type “Astra” provides 74 results.

With respect to FIG. 5a, the user query is subject to the incorporation of a refinement in respect of the “model” aspect and in particular, the refinement in FIG. 5a relates to a model referred to as a “Focus” manufactured by The Ford Motor Corporation. In this instance, a review of the user's search query is performed to determine whether or not the search query already includes the aspect of “model” as an existing parameter of the search query. With respect to the user's search query (refer FIG. 1), the inclusion of the parameters pertaining to The Ford Motor Corporation (node 40) and General Motors Holden (node 50) is detected and since the refinement relates to vehicles manufactured by The Ford Motor Corporation, the results of the sub-query relating to vehicles manufactured by General Motors. Holden (node 50) is removed from the expression tree of FIG. 1a and the results of node 50 are replaced by the results of a sub-search in respect of all vehicles according to the model “Focus” and the results of the previous logical OR operation (node 60) are also removed and replaced with the results of a logical AND operation between the results of the search of all vehicles according to The Ford Motor Corporation (node 40) and the results of the search in respect of all models according to “Focus” (node 150). The results of the logical AND operation are represented by node 160.

The next step in the method according to the embodiment of FIG. 5a is a logical AND operation between the search results of node 30 and the search results of node 160 thereby generating search results represented by node 170 which may be presented to the user as the results of a search for all Blue Sedans that are manufactured by the Ford Motor Corporation and are of the model “Focus”.

With reference to FIG. 5b, the user query is subject to the incorporation of a refinement in respect of the “model” aspect and in particular, the refinement in FIG. 5b relates a model referred to as an “Astra” manufactured by General Motors Holden. Similar to the method steps executed in respect of the expression tree depicted in FIG. 5a, the user's search query in the expression tree is amended to include the parameters pertaining to General Motors Hoiden (node 180) and the results of a search in respect of all models according to the “Astra” model (node 190). The results of the logical AND operation are represented by node 200.

The next step in the method according to the embodiment of FIG. 5b is a logical AND operation between the search results of node 30 and the search results of node 200 thereby generating search results represented by node 210 which represents the results of a refinement in respect of the user search query in relation to Blue Sedans with the refinement being those Blue Sedans manufactured by General Motors Corporation that are of the model “Astra”.

As previously mentioned, it is important when considering refinements to a user's search query to determine whether the facet to which the refinement applies already has a sibling present in the search query. If one or more siblings of the facet to which the refinement relates is not already present in the search query, then the refinement may be incorporated into the existing expression tree with a logical AND operation. However, if one or more siblings to which the refinement relates is already present in the search query, then it is necessary to amend the expression tree to replace the previous component of the expression tree comprising the one or more existing facets with the facet to which the refinement applies.

In the example of the above described embodiment, when considering a refinement of the aspect of make according to BMW when the user's search query includes Ford Motor Corporation OR General Motors Holden, then it is necessary to remove the component of the expression tree relating to the search results for “Ford Motor Corporation OR General Motors Holden” otherwise, if the aspect of BMW is combined as a logical OR with the previous results for “Ford Motor Corporation OR General Motors Holden”, the result will erroneously relate to all vehicles that satisfy the search criteria of Ford OR Holden OR BMW which is a larger set as compared with the available number of BMW's in the database that also satisfy the conditions of the user's search query (ie a Sedan body style that is coloured Blue).

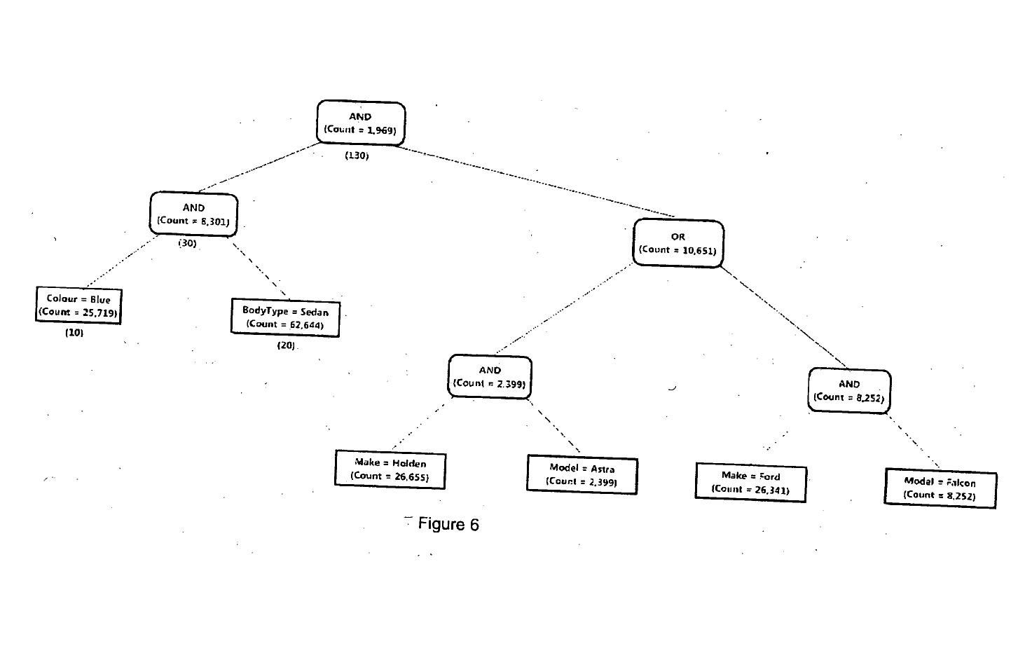

With reference to FIG. 6, a further diagrammatic representation of an expression tree is provided that corresponds with the user requesting a search for a Blue Sedan that is either a Holden Astra OR a Ford Falcon.

However, the car model “Astra” also has facets for “Badges” which are used to designate the series (or perhaps year) of a particular Make and Model of a vehicle.

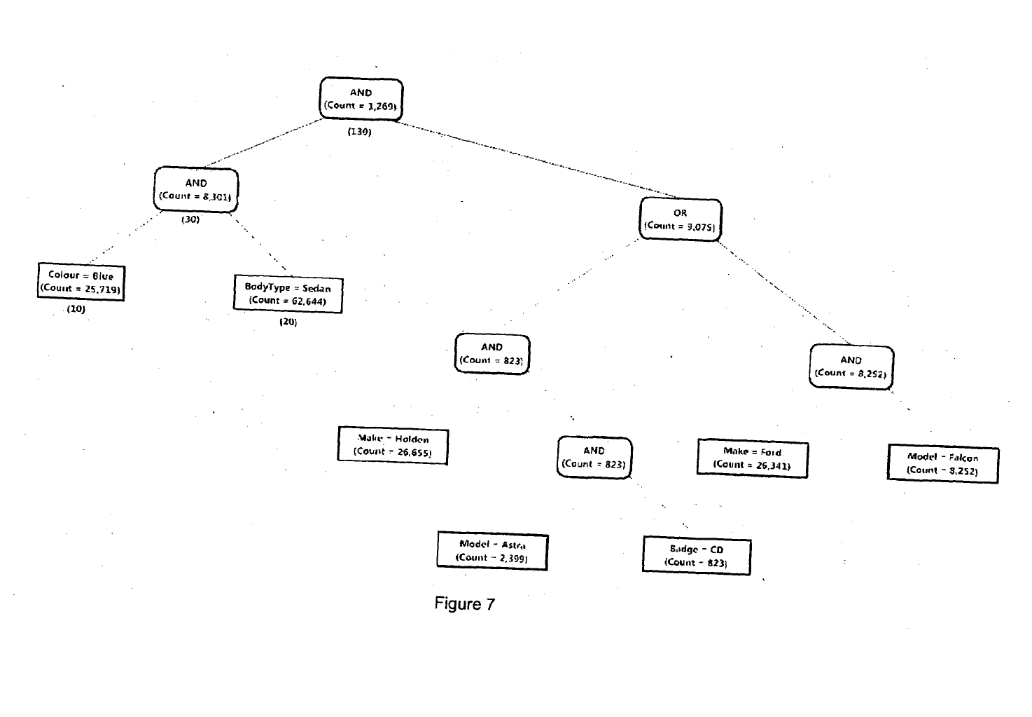

With reference to FIG. 7, a diagrammatic representation of an expression tree for a refinement to the search of FIG. 6 is provided wherein the user has selected the Badge “CD” for the Holden Astra vehicle and the expression tree reflects the search for a Blue Sedan that is either a Holden Astra with a CD Badge OR a Ford Falcon. The example of FIG. 7 highlights the hierarchical relationship between aspects and facets and in one embodiment, facets themselves can have facets that enumerate the possible values of the parent facet.

As will be appreciated by skilled readers, the present invention provides significant improvements to the flexibility of searching facilities provided to users whilst at the same time avoiding frustrating users during the process of executing a search to locate items of interest in a database.

In particular, providing users with information regarding valid refinements to their search query and providing them with the ability to “look ahead” significantly enhances the search experience as users can avoid conducting searches for refinements that would lead to a NULL result. This in turn avoids wasting the user's time and hence enhances the users search experience.

Throughout the specification, embodiments of the invention have been described that do not limit the invention to any one embodiment or specific collection of features. It will therefore be appreciated by those skilled in the relevant field of technology that, in view of this disclosure, various modifications and changes can be made to particular embodiments exemplified without departing from the scope and spirit of the present invention.

Throughout this specification and claims which follow, unless the context requires otherwise, the word “comprise”, and variations such as “comprises” and “comprising”, will be understood to imply the inclusion of a stated integer or step, or group of integers or steps, but not the exclusion of any other integer or step, or group of integers or steps.

The reference to any prior art in this specification is not, and should not be taken as, an acknowledgement or any suggestion that the prior art forms part of the common general knowledge in Australia.

1. A computer-implemented method of guiding a user during the construction of a search query in an attempt to locate an item of interest in a database of items, wherein the search index of the database is a hierarchical data structure that includes at least one aspect of the items in the database with the aspect having facets where the facets enumerate possible values of the aspect, the method including:
receiving a search query from a user;
building a search expression data structure according to the search query;
expanding the search expression data structure to determine the results for at least one facet available to refine the user's search query and presenting a representation of the results of the user's search query along with the result for the at least one facet to the user, thus providing guidance to the user for development of the search query regarding the existence of valid results for the at least one facet;
wherein, the search expression data structure includes logical OR operations and expanding the search expression data structure to determine the existence of valid results for the at least one facet includes removing components in the expression tree of the search query including facets that relate to the at least one facet in order to avoid generating incorrect results.

2. A computer-implemented method according to claim 1 wherein components in the expression tree of the search query that are removed include those components having facets for which the facet under consideration is a sibling within the family of facets that enumerate an aspect.

3. A computer-implemented method according to either claim 1 wherein the data structure representing the set of possible values of a facet is a tree structure with each non-leaf node representing an aspect of an item and leaf nodes representing facets of items.

4. A computer-implemented method according to claim 1 wherein the search expression tree is operable to include any combination of logical AND, logical OR and/or logical NOT operations.

5. A computer-implemented method according claim 1 wherein the search expression tree is operable to include any combination of logical EXCLUSIVE OR operations.

6. A computer-implemented method according to claim 1 whereupon expanding the search expression tree to determine the existence or otherwise of valid search results for a facet selectable as a refinement, the components of the expression tree for which results are already known are used in the determination of search results for the refinement facet rather than re-executing searches relating to those components of the search expression tree.

7. A computer-implemented method according to claim 1wherein the user is provided with a facility to remove previously entered refinements from the search query which effectively accommodates a “change of mind” facility as the user develops their search query.

8. A computer-implemented method according to claim 1 wherein during the determination of the presence or otherwise of valid facet refinements and presenting those to the user as guidance whilst developing their search query, the count value obtained for the valid refinements are also presented to the user.

9. A computer-implemented system to guide a user during the construction of a search query in an attempt to locate an item of interest in a database of items, wherein the search index of the database is a hierarchical data structure that includes at least one aspect of the items in the database with the aspect having facets where the facets enumerate possible values of the aspect, the system including:
at least one processor executing computer instruction code to receive a search query from a user;
at least one processor executing computer instruction code to build a search expression data structure according to the search query;
at least one processor executing computer instruction code to expand the search expression data structure to determine the results for at least one facet available to refine the user's search query, wherein the search expression data structure includes logical OR operations and expanding the search expression data structure to determine the existence of valid results for the at least one facet includes removing components in the expression tree of the search query including facets that relate to the at least one facet in order to avoid generating incorrect results; and
at least one processor executing computer instruction code to present a representation of the results of the user's search query along with the result for the at least one facet to the user, thus providing guidance to the user for development of the search query regarding the existence of valid results for the at least one facet.

10. A computer-implemented system according to claim 9 wherein components in the expression tree of the search query that are removed include those components having facets for which the facet under consideration is a sibling within the family of facets that enumerate an aspect.

11. A computer-implemented system according to claim 9 wherein the data structure representing the set of possible values of a facet is a tree structure with each non-leaf node representing an aspect of an item and leaf nodes representing facets of items.

12. A computer-implemented method according to claim 9 wherein the search expression tree is operable to include an combination of logical AND, logical OR, and/or logical NOT operations.

13. A computer-implemented system according to claim 9 wherein the search expression tree is operable to include any combination of logical EXCLUSIVE OR operations.

14. A computer-implemented system according to claim 9 whereupon expanding the search expression tree to determine the existence or otherwise of valid search results for a facet selectable as a refinement, the components of the expression tree which results are already known are used in the determination of search results for the refinement facet rather than re-executing searches relating to those components of the search expression tree.

15. A computer-implemented system according to claim 9 including at least one processor executing computer instruction code operable to allow the user to remove previously entered refinements from the search query effectively accommodating a “change of mind” facility as the user is developing their search query.

16. A computer-implemented system according to claim 9 wherein determining the presence or otherwise of valid facet refinements and presenting those to the user as guidance whilst developing their search query, the count value obtained for the valid refinements are also presented to the user.

17. A computer instruction code which, when executed by one or more processors, effects the steps of anyone or more of the methods defined in claim 1.
